(19) United States
(12) Patent Application Publication
(10) Pub. No.: US 2009/0011703 A1
(43) Pub. Date: Jan. 8, 2009

(54) Global Information and Hazard Warning System Using Satellite Navigation Systems and User Terminals

(75) Inventors: Detlef Flachs, Miesbach (DE); Christof Schaefer, Taufkirchen (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Muenchen (DE)

(21) Appl. No.: 12/162,448

(22) PCT Filed: Jan. 24, 2007
(86) PCT No.: PCT/DE07/00118

§ 371 Date: Jul. 28, 2008

(30) Foreign Application Priority Data
Jan. 26, 2006 (DE) 10 2006 003 702.2

(51) Int. Cl. G08B 27/00; H04B 7/185

(52) U.S. Cl. 455/12.1; 455/67.7; 340/7.58

(57) ABSTRACT

A method and device for a global information and early warning system, based on satellite navigation systems and user terminals, comprising the following steps and/or devices for carrying out this step: transmitting at least one warning message about one or more hazard area(s) by way of a satellite navigation system to user terminals in at least one information coverage area; receiving at least one warning message by means of a user terminal in the at least one information coverage area; and checking the warning message by means of the user terminal whether the user terminal is affected by the warning message.

This application is a national stage of International Application No. PCT/DE2007/000118, filed Jan. 24, 2007, which claims priority under 35 U.S.C. §119 to German Patent Application No. 10 2006 003 702.2, filed Jan. 26, 2006, the entire disclosure of which is herein expressly incorporated by reference.

### BACKGROUND AND SUMMARY OF THE INVENTION

The invention relates to a global information and hazard warning system, which is based on satellite navigation systems and their user terminals.

In order to be able to inform persons of existing hazards in certain neighboring geographical areas, and also distant geographical areas, there is a need for a system that allows warning messages and/or general information to be sent to persons who are or will be in these geographical areas. In order to be able to effectively use such a system, it has to be possible to reach as many persons as possible with the system and, in particular, in as short a period of time as possible.

Existing satellite communication technologies do not satisfy this demand. One drawback with these technologies is that in their time they found only a limited user group. Owing to the high cost of acquisition and the operating costs (for example, the communication costs) one must expect that even in the future these technologies will propagate only to a limited extent. Consequently only a limited group of persons can be reached currently and in the future with the aid of satellite communication. Another drawback with satellite communications is that the geographical selection of a specific subgroup of user terminals has to be guaranteed by the satellite system itself-a requirement that demands, for example, knowledge of the current position of the user terminal in the satellite system.

In addition, both existing satellite-based and the existing and still in progress ground-based methods of end-to-end communication require the knowledge and identification of all user terminals that are to be reached as well as a time consuming, sequential configuration of the links between the system and the individual user terminals. Another drawback is that most of the existing techniques are earth-based systems. That is, they depend on an existing and functioning ground-based infrastructure in the target area of the warning message.

The professional literature distinguishes between different types of systems. Owing to the blanket market penetration of terrestrial mobile radio networks, they offer a good possibility of transmitting information and warnings to terminal users. In addition, SMS and cell broadcast are especially suited for transmitting messages to many users within a radio cell. The drawback is the expected network failures due to damage to the infrastructure and/or network overloads in the event of an unforeseen calamity. A global coverage is not achieved with this technique and is also not planned. Areas in the vicinity of the coast and the open seas, mountains and also sparsely populated areas are to some extent not covered at all.

In contrast, mobile satellite radio systems occupy these niches and offer regional and global coverage. Of course, experience has shown that these systems are not practical for the mass market. The large volume and weight of the terminals and the high transmission costs prevent it.

Terrestrial television for portal application can be realized with DVB-T (digital video broadcasting-terrestrial). However, in this case, too, the entire area is not provided with service. The DVB-H (for handhelds) standard has been established for mobile television applications. In this case, too, the coverage is not total; and it is not easy to find the position of the terminal by means of DVB-T/H signals.

Terrestrial radio transmitters and also digital satellite radio (for example, Sirius, XM satellite radio) also offer an infrastructure that is suitable for transmitting warnings. However, these systems are not globally implemented and do not permit an accurate position finding of the terminal.

One object of the present invention is to provide a method, which functions reliably, independently of a terrestrial infrastructure and which can emit warning messages to a target group quickly, effectively and with a high degree of coverage. A target group is defined as those persons, who are or will, at a certain point in time or in a certain period of time, be in a predetermined geographic area.

This and other objects and advantages are achieved by the method according to the invention, which is intended for a global information and early warning system, based on satellite navigation systems and user terminals. It comprises the following steps: transmitting at least one warning message about one or more hazard area(s) by way of a satellite navigation system to user terminals in at least one information coverage area; receiving at least one warning message by means of a user terminal in the at least one information coverage area; and checking the warning message by means of the user terminal whether the user terminal is affected by the warning message.

According to the invention, the method as described may also include one or more of the following:
deciding that the user terminal is affected by the warning message, when at least one position of the user terminal is in one of the hazard areas of the warning message;
informing the user of the user terminal by means of a warning signal that a warning message was received, when the user terminal has decided that the user terminal is affected by the warning message;
providing the warning signal in visual, acoustical or tactile form;
communicating the content of the warning message to a user of the user terminal, when the user terminal has decided that the user terminal is affected by the warning message;
detecting at least one hazardous situation for at least one hazard area; emitting a warning with information about the at least one hazardous situation to control systems of the satellite navigation systems; and inserting the warning as a warning message into signals of navigation satellites or other transmitting systems of the satellite navigation systems;
at least one warning message is carried out by navigation satellites and/or other transmitting systems of the satellite navigation systems;
some or all of the other transmitting systems of the satellite navigation systems are pseudolites;
some or all of the transmitting systems of the satellite navigation systems are ground-based and/or space-based augmentation systems or components of such augmentation systems;
the decision whether the user terminal is affected by the warning message is carried out automatically;
the decision whether the user terminal is affected by the warning message is carried out only after release by a user;
the position of the user terminal is a current and/or at least a future position of the user terminal;
the at least one future position is a planned and/or forecast position;
the warning message comprises at least one identifier of the warning message and data for describing at least one hazard area;
the warning message comprises at least one free text field, at least one validity time, at least one validity time period, at least one activation flag for additional information, at least one activation flag for activities of the user terminal and/or at least one authorization information;
the method is performed with a user terminal, which is intended for a satellite navigation system and which comprises a first device for receiving at least one warning message in at least one information coverage area and a second device for checking at least one received warning message whether the user terminal is affected by the warning message; and
the method is performed with a satellite navigation system, which is intended for carrying out a global information and early warning service and which comprises a first device for transmitting at least one warning message about one or more hazard area(s) and the inventive user terminal.

Other advantageous embodiments of the invention are disclosed in the description of the invention with reference to the figures.

One advantage of the inventive method is the utilization of the high degree of coverage of existing satellite navigation systems for the transmission of warning messages. Together with the wide spread of existing user terminals for satellite navigation systems, many interested parties can be reached by warning messages. Owing to the global coverage, which is achieved by satellite navigation systems, sparsely populated areas can also be reached—for example, on the sea, in the mountains and in underdeveloped areas, where service is not provided, for example, with mobile telephone networks.

Another advantage of the method according to the invention is that the transmission capacities of existing and planned satellite navigation systems are adequate for the use of said inventive method. That is, the existing capacities do not have to be expanded. It is achieved by limiting the inventive method to the transmission of short—optionally standardized—messages.

Another advantage of the method according to the invention is that the use of the communication possibilities of existing and planned satellite navigation systems makes possible the reliable performance of the method, independently of a terrestrial infrastructure. Therefore, quick and effective warning messages can be sent. The terrestrial infrastructure, required for the satellite navigation system, is usually globally distributed and exhibits a high degree of redundancy, which is required for the uninterrupted operation of the system for positioning purposes. As a result, the necessary terrestrial infrastructure—for example, in contrast to the locally limited design of a mobile communication system—is insensitive to locally and regionally defined faults, failures and influences.

Furthermore, the use of the communication possibilities of existing and planned satellite navigation systems also offers the advantage of global availability, independently of the existing terrestrial communication infrastructures. In addition, the configuration of the satellite navigation systems has to meet the minimum requirements for positioning. That is, at least four satellites have to be visible at any time at every point of the earth. This design requirement constitutes a high degree of coverage and redundancy for a warning system, which is based on satellite navigation systems and which also guarantees a necessary minimum availability even in environments with complicated reception conditions.

Due to the combination of existing satellite navigation systems with existing user terminals, an existing technique is applied that can be used immediately without generating any additional expenses for the operator or the users.

Through the use of mass market-oriented user equipment, in particular with respect to the size, weight, price and complexity in the application, a high degree of mass market penetration is guaranteed.

At the same time there already exists a plurality of professional applications of the satellite navigation, so that the result is a high penetration into the professional and governmental user groups. This has the advantage that even in areas, in which the population does not usually have technical devices on a large scale for reasons relating to the social and economic conditions of the people, suitable receivers are available at least at the government offices responsible for the coordination in the event of an unforeseen calamity. Thus, it is possible to receive warning messages and to facilitate appropriate reactions in the affected areas.

Another advantage of the inventive method is that the decision whether the user of a terminal is affected by a warning message is shifted to the user terminal. The user terminal can check the relevance of the received information for the user of the terminal by means of the transmitted information about the geographical and temporal relevance of the warning message and the current position and/or the planned future position that is determined in the terminal. The user terminal makes the decision autonomously, based on its current or its planned future position. Then the warning messages are transmitted only to the persons of the target group of the warning messages. That is, the persons, who are and/or will be at a certain time or in a certain time period in a predetermined geographical area, for which a warning message is transmitted.

As a result, the invention also protects the user's private sphere, because owing to the autonomous decision of the user terminal, a dynamic allocation and/or monitoring on the part of the user is not necessary. There is no need for the system to know which user terminals are located at a certain time in the hazard area, in which the warning message are to be distributed. The necessity of having to have identified in detail all of the affected terminals in order to be able then to address them directly ceases to exist.

The method according to the invention is based on the use of the satellite navigation communication to disseminate warning messages and the information about the geographical and, if desired, temporal validity of the warning message. In order to use the warning service, the terminals need have only the possibility of receiving, processing and evaluating satellite navigation messages as well as have positioning capabilities. In this case the positioning ensues ideally via satellite navigation, but can also be supplemented with other methods and techniques or based solely on such methods and techniques. In contrast, a dedicated communication component in the terminal is not absolutely mandatory. Even if hybrid terminals (terminals with communication and positioning component) are used, the solution works uniformly on all systems, independently of the use and the operation of individual communication systems, communication networks and communication services.

Consequently there is an effective, fast and economical possibility of sending information having a negligible volume of data into a certain spatially defined area.

Other advantages follow from the expected high spread of the satellite navigation terminals through the introduction of such devices in mobile telephones. Such a trend would be started by various enterprises; and it is expected that this will become a quasi standard for the mobile radio market.

The method according to the invention is based on different capacities of the satellite navigation signals. This includes, among other possibilities, the transmission of information into reserved areas of the navigation messages themselves.

Other objects, advantages and novel features of the present invention will become apparent from the following detailed description of the invention when considered in conjunction with the accompanying drawings.

### BRIEF DESCRIPTION OF THE DRAWINGS

FIG. 1 depicts one example of a global early hazard warning system;

FIG. 2 depicts one possible basic format for a warning message; and

FIG. 3 depicts one possible expanded format for a warning message.

### DETAILED DESCRIPTION OF THE DRAWINGS

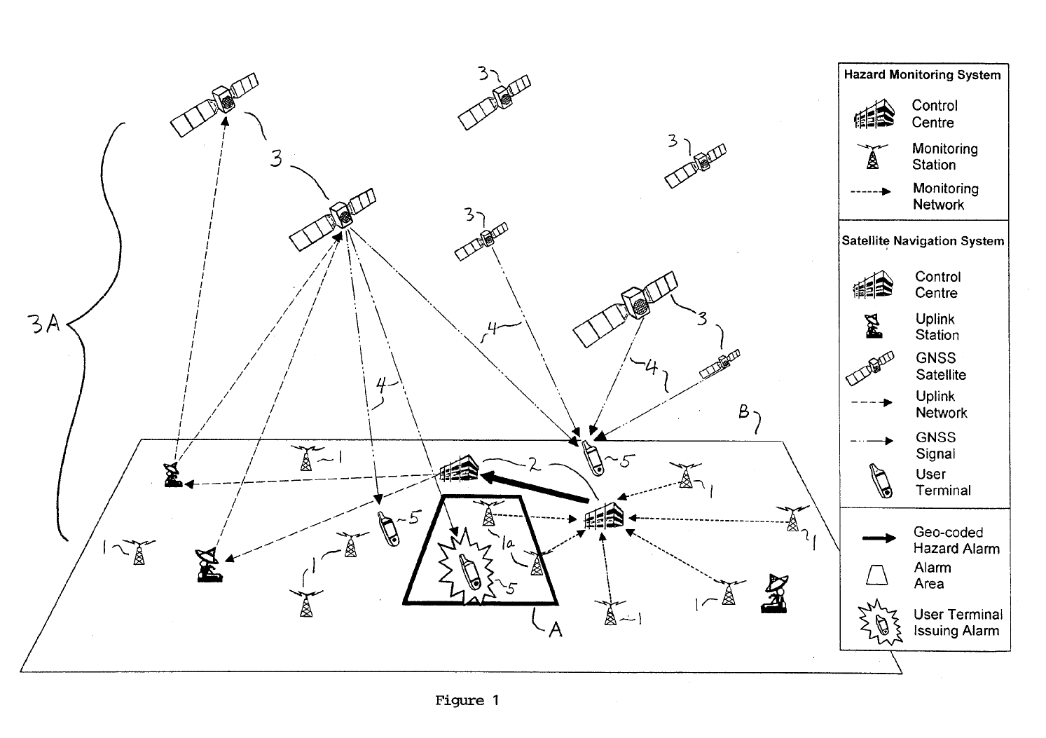

FIG. 1 shows by way of one example a global early hazard warning system, which is based on a satellite navigation system and with which the inventive method can be operated.

According to one embodiment of the present invention, monitoring systems 1 detect a hazardous situation for a specific area A (for example, by means of sensors in the case of natural disasters or by means of an evaluation of the situation in the event of unrest or other political dangers or also environmental catastrophes). The affected monitoring systems 1a then send a warning with the corresponding information to a control center 2 of one or more satellite navigation system(s). The warnings with the corresponding information of the monitoring system are fed over the regular receiving channels of the satellite navigation system to navigation satellites 3 or other transmitting systems of a satellite navigation system 3A (for example, pseudolites). These warnings with the corresponding information are inserted as a warning message into a corresponding signal 4 of the satellite navigation system, beamed from the satellite navigation system and, thus, fed from navigation satellites 3 or other transmitting systems (for example, pseudolites) of the affected satellite constellation to all user terminals 5 that can be reached.

The warning messages are inserted-depending on the possibilities of the satellite navigation system that is used—either into a free slot of a navigation signal (navigation communication) or into communication messages that are intended for this purpose and which are provided by specific signals.

The present invention distinguishes between different types of geographical areas—that is, hazard areas and information coverage areas. A hazard area for the warning messages is a geographical area A, for which it is expected that it will be adversely affected by hazardous events. The hazard areas are communicated, for example, by means of the aforementioned monitoring systems to the control center of the satellite navigation system. An information coverage area for warning messages is a geographical area B, into which the warning messages are beamed. The information coverage areas are defined by the coverage of the satellite constellations. For example, warning messages about a hazard area in Africa can be transmitted to target groups in an information coverage area in Europe.

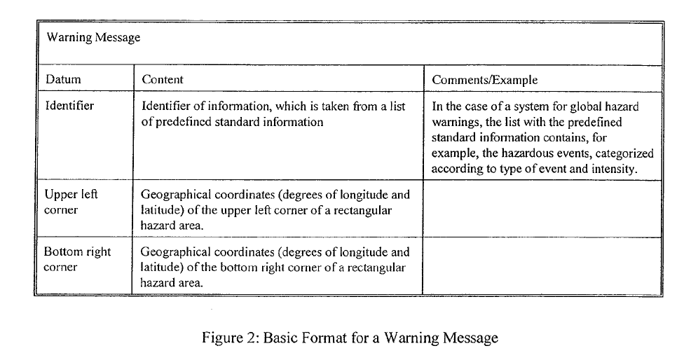

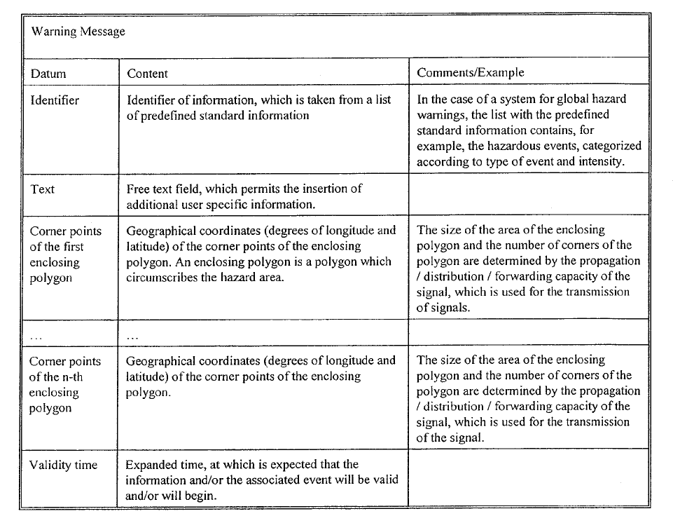

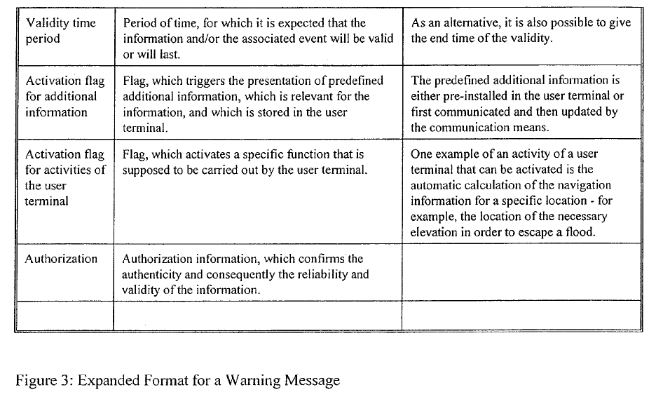

The hazard areas A are communicated as part of the warning messages to the user terminals in the information coverage areas (see FIGS. 2 and 3). Hazard areas can assume any geometrical shape and comprise one or more contiguous geographical area(s). The information coverage area B for warning messages, on the other hand, will usually comprise at least the associated hazard area of the warning messages in its entirety. In this case the warning messages would be received by all persons, who are provided with a user terminal and are in the hazard area.

According to the invention, the information coverage areas B and the hazard areas A can also overlap or be totally separate geographical areas. In this case warning messages would also be received by persons, who are provided with a user terminal and are outside the hazard area. Such warning messages can be important, for example, to persons, who plan to travel into the hazard area or who merely express a general interest in this area and, hence, want information about said area.

Ideally the information coverage area will include the hazard area in such a way that included are persons, who are in a surrounding area of the hazard area, in which it may be assumed that they can reach, as planned, the hazard area during the duration of the hazard.

Following receipt of a warning message, a user terminal checks whether it is affected by the received warning message. This checking can be set manually by the user of the terminal and takes place either automatically at once or at a time that is fixed by the user or is suppressed.

To this end, upon receipt of the warning message, the user terminal automatically retrieves its current position with the aid of the means of the satellite navigation or resorts to a stored position. These two options can be set manually by the user of the terminal. For example, in periods of major changes in position (for example, continuous movement with an airplane) the user can select the first option; and in periods of fewer or no changes in position, the user may select the second option. The second option also makes it possible to receive the relevant warning messages in the event of a preset route of future planned positions (navigation) or to receive general information about an area of interest, but without any specific plans of staying in that immediate area.

If the current position or a stored position is within the hazard area A, the terminal informs the user about the received warning message. This can occur in different ways—for example, visually, by means of a display of the warning message on a screen (display) of the user terminal; or acoustically, by means of voice output; or by means of a suitable combination. The display of the warning message can be preceded by a corresponding warning signal, which indicates to the user the receipt of a warning message—for example, visually through a change in color or a flashing of the display; acoustically by means of a specified warning signal and/or by tactile sensation by means of a vibration signal. In addition, the display of the warning message can also contain additional information, which is pre-stored in the terminal, and/or can comprise the activation of a specific function of the user terminal 5 (for example, determining the route for predetermined and/or predefined target points/areas). These different options can be set manually by the user.

In another embodiment, when the user terminal checks whether it is affected by the received warning message, the user terminal 5 uses one or more future position(s). Future positions can be used together with the current position or instead of the current position. These options can be set manually by the user. In this case future positions are either planned positions or estimated or forecast positions. The planned positions are entered into the terminal by the user and relate, for example, to a planned route for the predetermined and/or predefined target points or target areas. Therefore, the route can be provided with time-related information, which indicates the time, at which one will reach a route point. Estimated or forecast positions are derived from an estimation of the user terminal, for example, from stored earlier current positions of the terminal and/or from a stored planned course (navigation or guidance mode).

The future positions of the navigation or guidance mode can be given by a navigation and guidance process, which determines the positions to a fineness that is to be determined by the user of the terminal, based on a plan, entered by the user, or based on an estimation method, selected by the user.

In another embodiment, when the user terminal 5 checks whether it is affected by the received warning message, it uses, in addition to the current position and/or the future positions, a validity period, which is included in the warning message. A validity period indicates the period of time, for which the warning message will be valid. If, for example, the points of a route in the hazard area, will not be reached, according to the route planning, during the validity period, then the terminal can decide that it is not affected by the warning message.

When the current position information is used, the warning message is communicated to the user only if the current position is inside the hazard area during the validity period. Warning messages can also relate to future hazardous events. These options can be set manually by the user. In addition, the use of a validity period for the warning message makes it possible for the users, who are not or will not be in the hazard area during the validity period, but whose planned route will take them through this area just after the end of the acute hazardous event, to change the route accordingly in order to circumvent the consequences of the event—for example, destruction.

If a stored and/or estimated future position says that the user will already be outside the hazard area during the validity period, the warning message may be sent, nevertheless, in order to guarantee that the user is, nevertheless, not affected by the hazard owing to a change in his plans. Such a message can also be suppressed. This option, too, can be set manually by the user.

In another embodiment the satellite navigation system 3A also comprises the function of limiting the propagation of the warning messages to certain selected satellites and, thus, to determine in different ways the information coverage areas of a warning message. In this case the information coverage areas are determined by the monitoring systems.

An additional embodiment uses a hybrid user terminal, which connects the functionality of the satellite navigation to the functionality of the satellite communication. This allows the option of also transmitting larger amounts of data for the purpose of adding additional information to the pure warning message.

The invention also includes data formats of warning messages. FIG. 2 shows one example of a basic format of a warning message; and FIG. 3 shows one example of an expanded format of a warning message.

FIG. 2 shows an example of a warning message that transmits low information content. In this warning message, the hazard area of the warning message is defined by a simple geometric shape. The example depicts the case of a rectangle. However, any other simple geometric shape can be used just as well—that is, any shape that can be described by a few data items. In this case the information content of the warning message is limited to an unambiguous identifier, which indicates the event, to which the warning relates.

FIG. 3 shows an example of an expanded warning message, in which the hazard area can be freely defined by means of one or more polygon(s), by displaying the corners and edges for these polygons (for example, rectangles, circles, polygons or a combination of such shapes). In addition, an expanded information unit is available. Besides the expected time at which the hazardous event will occur, a validity period is communicated, indicating how long the associated hazardous event will last. Furthermore, there is an activation flag enables and triggers the presentation of predefined additional information that is relevant in the case of the transmitted type of warning and that is stored in the user terminal. In addition, there is an activation flag for the user terminal, which activates specific functions that are to be carried out by the user terminal (for example, in the case of an impending flood the determination of the shortest route to points of higher situated terrain). The authorization key confirms the authenticity of the transmitter and, thus, the reliability of the communicated information.

The cited information content serves only as an example of an expanded warning message. Therefore, the inventive idea is not limited to this information content. It is possible to give other types of information. For example, it is possible to give an additional time period, which indicates how long the hazardous event will adversely affect the hazard area. Furthermore, combinations and subquantities of the cited information content are also possible.

The choice of the content for the warning message has a significant effect on the volume of the data that have to be transmitted.

Due to the type of warning message and the coverage and availability requirements that satellite navigation systems must meet, time periods ranging from 10 to 20 seconds for the receipt of complete warning messages are acceptable. Consequently the invention can also be implemented on such systems that only exhibit low capacities for the transmission of data. Thus, the invention can be implemented, in particular, by inserting warning messages into the navigation signals of the satellite navigation systems.

The above described embodiments supplement each other in such a way that they can be combined together in any arbitrary way. For this reason any combination of the above described embodiments has to be construed as part of the disclosure of the invention and as embodiments of the invention.

Furthermore, the user terminals for the satellite navigation systems, which are configured for carrying out the method according to the above described embodiments, are disclosed.

In addition, disclosed are satellite navigation systems, which are intended for carrying out a global information and early warning service and which are configured for carrying out the method, according to the above embodiments, and comprise a user terminal, according to the present invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-17. (canceled)

18. A method of operating a global information and early warning system, based on satellite navigation systems that includes user terminals, said method comprising:
transmitting at least one warning message containing information about at least one hazard area, via a satellite navigation system, to user terminals in at least one information coverage area;
receiving said at least one warning message via a user terminal in the at least one information coverage area; and
checking the warning message via the user terminal, to determine whether the user terminal is affected by the warning message.

19. The method, as claimed in claim 18, further comprising:
said user terminal determining that the user terminal is affected by the warning message when at least one position of the user terminal is in one of the at least one hazard area of the warning message.

20. The method, as claimed in claim 19, further comprising:
when the user terminal has decided that the user terminal is affected by the warning message, informing a user of the user terminal by means of a warning signal that a warning message was received.

21. A method, as claimed in claim 20, wherein the warning signal is one of visual, acoustical and tactile.

22. A method, as claimed in claim 19, further comprising:
when the user terminal has decided that the user terminal is affected by the warning message, communicating the content of the warning message to a user of the user terminal.

23. The method, as claimed in claim 18, further comprising:
detecting at least one hazardous situation for at least one hazard area;
sending a warning with information about the at least one hazardous situation to control systems of the satellite navigation systems; and
inserting the warning as a warning message into signals of navigation satellites or other transmitting systems of the satellite navigation systems.

24. The method, as claimed in claim 18, wherein the transmission of the at least one warning message is carried out by transmitting systems of the satellite navigation systems.

25. The method, as claimed in claim 24, wherein said transmitting systems of the satellite navigation systems include at least one of navigation satellites and pseudolites.

26. The method, as claimed in claim 24, wherein some or all of the other transmitting systems of the satellite navigation systems are ground-based and/or space-based augmentation systems or components of such augmentation systems.

27. The method, as claimed in claim 18, wherein the determination whether the user terminal is affected by the warning message is carried out automatically.

28. The method, as claimed in claim 18, wherein the determination whether the user terminal is affected by the warning message is carried out only after release by a user.

29. The method, as claimed in claim 19, wherein the at least one position of the user terminal is one of a current position and a future position of the user terminal.

30. The method, as claimed in claim 29, wherein the future position is a planned and/or forecast position.

31. The method, as claimed in claim 18, wherein the warning message comprises at least one identifier of the warning message and data for describing the at least one hazard area.

32. The method, as claimed in claim 31, wherein the warning message comprises at least one free text field, at least one validity time, at least one validity time period, at least one activation flag for additional information, at least one activation flag for activities of the user terminal and/or at least one authorization information.

33. A user terminal in a satellite navigation system comprising:
a first device for receiving at least one warning message in at least one information coverage area; and
a second device for checking the at least one warning message to determine whether a user terminal is affected by the warning message.

34. Satellite navigation system for carrying out a global information and early warning service, said system comprising:
a first device for transmitting at least one warning message about one or more hazard area(s); and
a user terminal as claimed in claim 33.

35. A method of publishing a hazard warning, said method comprising:
a monitoring system determining the existence of a hazard in a hazard area;
said monitoring system sending a warning signal, indicative of a determined hazard, to a control system of a satellite navigation system; and
said satellite navigation system sending said warning message in signals that are transmitted to user terminals of said satellite navigation system, which user terminals are within an information coverage area;
wherein, said signals are transmitted via at least one of navigation satellites and psuedolites of said satellite navigation system.

36. The method according to claim 35, wherein:
said user terminals determines whether said user terminal is affected by said warning message.

37. The method, as claimed in claim 36, further comprising:
when the user terminal has decided that the user terminal is affected by the warning message, informing a user of the user terminal by means of a warning signal that a warning message was received.
